(19) United States
(12) Patent Application Publication
(10) Pub. No.: US 2007/0152377 A1
(43) Pub. Date: Jul. 5, 2007

(54) Method of making of cementitious article resembling a naturally occurring item

(76) Inventor: Alan R. Bradberry, Shreveport, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 11/327,529

(22) Filed: Jan. 5, 2006

(51) Int. Cl. B31B 1/60; B32B 9/04; B29C 35/08

(52) U.S. Cl. 264/425; 428/411.1; 156/60

(57) ABSTRACT

A method of making a cementitious product that resembles a naturally found item is disclosed. The original item, for instance a piece of petrified wood, is used as a guide in mold-making and subsequent decoration of the cast product. The mold is made by applying coats of resinous composition to the exterior of the original product and stabilizing the coats by securing an open-weave fabric between the coats. The resultant flexible mold is used for pouring of a cementitious mixture and forming a cast that closely resembles the appearance and textural characteristics of the original item.

### BACKGROUND OF THE INVENTION

This invention relates to a process of making cementitious articles that resemble naturally found objects, such as petrified wood pieces.

Many artisans make free-form sculptures from natural materials, such as wood, stone, marble and the like. Most of the natural materials require a high degree of skill and knowledge of the material to be properly handled. One of such materials is petrified wood, which is a type of fossil, in which the tissues of a dead plant are replaced with minerals. The petrifaction process takes place underground when wood materials become buried under the sediment. Then the minerals present in the water, such as silicate flowing through the sediment deposits penetrate through the plant's cells, gradually replacing the plant's lignin and cellulose, leaving a stone cast in the shape of the wood piece in its place. Minerals, such as manganese, iron and copper that are naturally present in the water or mud during the petrifaction process give the petrified wood a variety of color ranges that are most admired by the consumers.

While the silicates are almost colorless, other minerals give the petrified wood a high degree of coloration, making the petrified wood piece more attractive. For instance, iron imparts yellowish/reddish tint to the article, carbon makes the article black, cobalt imparts greenish/bluish tint, manganese gives the petrified wood pinkish hue, and iron oxide imparts red, brown or yellow color. These colors blend together in an unpredictable combination, which makes every piece of petrified wood unique. The texture of petrified wood can be very detailed, often reflecting the internal structure of the plant, from which the petrified wood piece originated. Structures, such as cellulose cells and vascular tissues are often observed in the petrified wood articles.

The petrified wood items are found in many countries of the world. For instance, there is Petrified Forest National Monument in Santa Cruz, Argentina, and the Argentine Patagonia has trees measuring more than 10 feet in diameter and hundred feet long. The petrified trees in the United States are somewhat smaller usually measuring less than 6 feet in diameter. The most famous petrified wood is found in Petrified Forest National park in Arizona. Wood found in that area is a prized commercial item, particularly when it is cut and polished, such as done with valuable minerals. As a result, the articles made of petrified wood are costly; require special skills for polishing and making of decorative objects.

As a result, there exists a need for a method of making a decorative article that resembles a naturally found substance, such as petrified wood from a readily available supply of materials such that at least one surface of the formed article resembles the structure of the petrified wood piece.

### SUMMARY OF THE INVENTION

It is, therefore, an object of the present invention to provide a method of making an article that has one or more exterior surface resembling the naturally formed petrified wood item.

It is another object of the present invention to provide an article of manufacture made according to the process of the present invention, with said article having at least one surface resembling petrified wood items.

These and other objects of the present invention are achieved through a provision of a method wherein a cementitious composition is used for casting an article that may have purely aesthetic or utilitarian characteristics. According to the method of the present invention, the artisan selects a naturally-occurring item, for instance a piece of petrified wood, and then applies one or more coats of liquid resinous substance to at least one or more exterior surfaces of the item. Then the artisan positions a loose open-weave fabric, for instance cotton gauze, over the coated surfaces and secures the fabric with an additional coat of the liquid resinous substance. The coating and the fabric are allowed to dry and form a flexible deformable primary mold having an inner cavity configured as a mirror image of the original item.

A support device, for instance a cage formed from a mesh material is used for supporting the primary mold during casting. A cementitious curable casting composition is then poured into the mold cavity and allowed to cure, thereby forming the three-dimensional article. If desired the primary casting can be decorated to resemble the original petrified wood item or used as a base for further molding and casting of secondary casts. The process of producing the secondary casts resembles the original process inasmuch as the body portion of the casting is covered with resinous coating(s) and open-weave fabric to form a secondary mold. The mold is then used for making a secondary cast, which has exterior surface closely resembling the textured surface of the original piece.

The secondary cast can be cut, drilled, buffed or otherwise processed to form a utilitarian item is desired. Such item may be a candleholder, a vase, a planter, a birdbath and the like. Of course, the secondary cast can be also painted to duplicate the unique colors of the petrified piece and used as a purely ornamental object.

### BRIEF DESCRIPTION OF THE DRAWINGS

Reference will now be made to the drawings, wherein like parts are designated by like numerals, and wherein

FIG. 1 is a perspective view of an example of an article made in accordance with the present invention.

FIG. 2 is an illustration of a step of the process of the instant invention, wherein resinous substance is applied as a coat to the exterior surface of a piece of petrified wood.

FIG. 3 is an illustration of a step of the process wherein an open-weave fabric is secured around the petrified wood piece for covering the coat of resinous substance.

FIG. 4 is an illustration of a step of the process showing the primary flexible mold being removed from the item of petrified wood.

FIG. 5 is an illustration of an article of petrified wood and the mold produced in the steps of the process of the present invention.

FIG. 6 is an illustration of the step in the process wherein a piece of support device material is wrapped around the item of petrified wood.

FIG. 7 is an illustration of a step in the process wherein a cementitious casting medium is poured into the mold, with the support device supporting the mold.

FIG. 8 illustrates a step in the process when the support device is removed from the mold by inverting the mold.

FIG. 9 is an illustration step in the process wherein the mold is removed from the cured casting.

FIG. 10 is an illustration of a step in the process wherein the cementitious casting is carved to form an inner recess.

FIG. 11 is an illustration of a step in the process wherein the interior recess is polished or buffed.

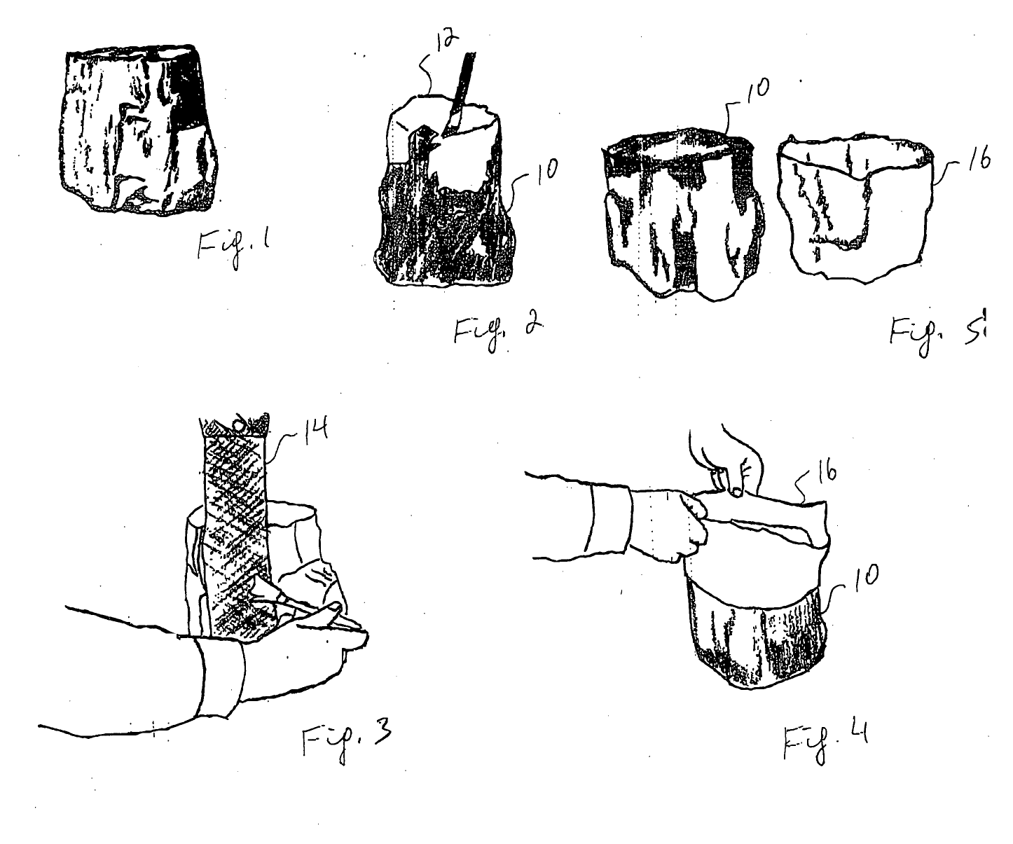

### DETAILED DESCRIPTION OF THE PREFERRED EMBODIMENT

While the making and using of the embodiment of the present invention are discussed in detail below, it should be appreciated that the present invention provides many applicable inventive concepts, which can be applied in a wide variety of specific contexts. The specific embodiments discussed herein are mainly illustrative of specific ways to make and use the invention and do not limit the scope of the invention.

Turning now to the drawings in more detail, and in particular to FIG. 2, numeral 10 designates an item of naturally-occurring item, in this case a piece of petrified wood. In the naturally found item, the wood's cellulose cells have been replaced with minerals and silicate. Depending on the area of petrifaction, the piece of petrified wood 10 can be of various dimensions and coloration. Some pieces of petrified wood have sharp edges, which features lend themselves more interesting for use in making decorative items. Regardless of the textural characteristics of the starting item the process of casting a cementitious article resembling the original item is as described below.

The first step of the process in accordance with the present invention is application of a liquid rubber composition, for instance liquid latex. Natural rubber originates in the Hevea tree and is made from sap that runs deep inside the tree where the latex drops in a layer outside the candium. Natural sap is processed to form a liquid latex concentrate for other products that is used for manufacturing a wide variety of items. Of course, there are other rubber-like liquid materials that can be used in forming the mold, as long as they have the physical characteristics resembling that of liquid latex rubber.

The latex layer(s) shown in FIG. 2 are identified by numeral 12. When the liquid latex composition is applied to the item of petrified wood, it fills the cracks and crevices of the petrified wood item 10 thereby closely following the exterior surface of the petrified wood item. The layer of latex is allowed to dry 4 to 24 hours. One or more additional coatings of resinous substance may be applied to make the latex coating more stable. The resinous layers are allowed to partially dry before an additional coat is applied.

When the final layer of the rubber material is relatively dry, a piece of loose open-weave fabric, for instance cotton gauze 14 is positioned on the outside of the latex layers. Another layer of rubber material such as liquid latex concentrate is applied to the gauze to further insure stability of the mold. The gauze and the applied layers of latex are allowed to dry for 72 hours or more so as to allow all layers of coating and the fabric to bond together and form a flexible, deformable, somewhat resilient primary mold 16.

The next step in the process allows the craftsman to remove the now formed primary mold 16, as shown in the illustration of FIG. 4. The petrified wood can remain intact and can be used for making future molds if necessary. The petrified wood item is retained as a guide for painting and decorating of the finished cast product as will be explained in more detail hereinafter.

As can be seen in FIG. 5, the mold 16 is a mirror image of the exterior of the petrified wood item 10. The next step in the process involves making a support device for the mold 16 for use during casting process. The support device should preferably be of a configuration that closely resembles the exterior of the mold 16.

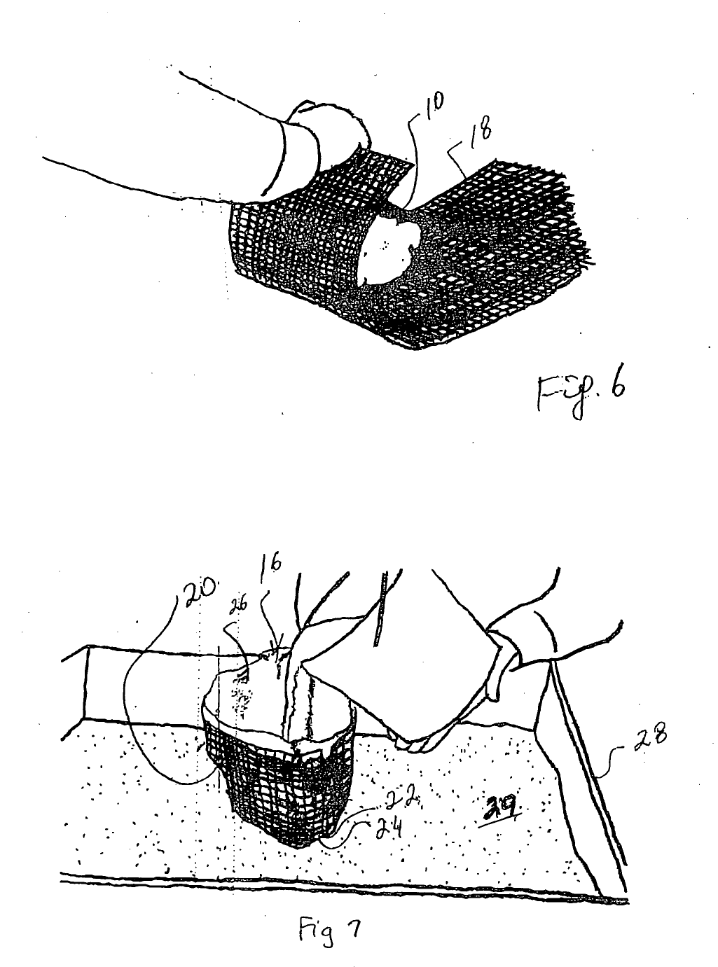

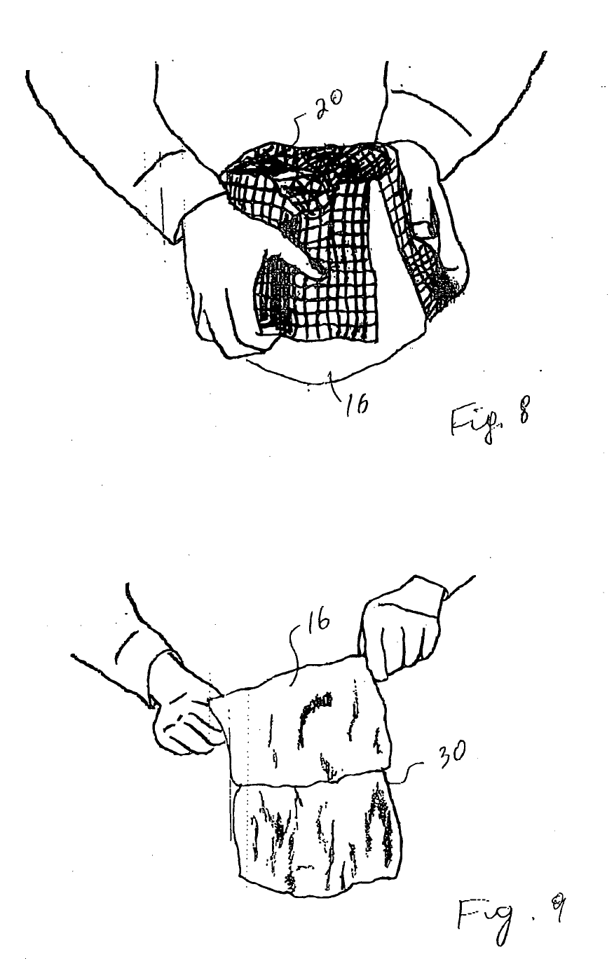

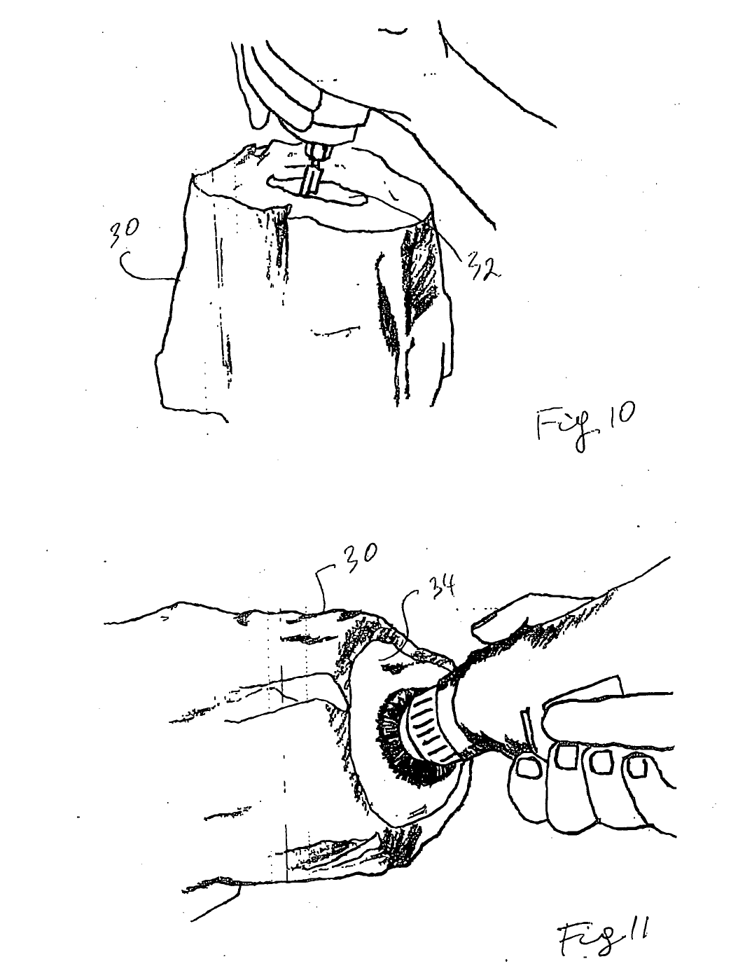

To achieve this purpose, the artisan can fashion the support device by wrapping a flexible bendable material around the item of petrified wood. As an example, a sheet of wire mesh is wrapped around the item 10, around sides and bottom thereof. If desired a tack hammer is used to bend the mesh around and into the characteristics irregularities of the piece of petrified wood. The general shape of the resultant support device, or cage 20 (FIG. 7) closely follows the configuration of the original piece 10 and consequently, the exterior of the mold 16.

The cage 20 is then removed from the piece of petrified wood and the rubber mold 16 is positioned inside the cage 20. If the support device 20 is formed from a sheet material, the artisan may find it beneficial to secure the adjoining edges 22 and 24 of the sheet by tying or lacing the edges 22, 24 together to ensure the stability of the support device 20. Of course, other types of the support device may be used if desired, although a support device that follows the configuration of original item is preferred.

If desired, the interior of the mold 16 can be coated with a mold-releasing agent that can be applied by brush or sprayed to the interior of the mold 16. The mold release agent may contain a soapy substance, which will make it easier for the finished product to be removed from the mold once it has dried. If desired, the cage 20 along with the mold 16 can be placed in a container 28, which has small pebbles or sand 29 deposited on the bottom of the container. The sand surface provides greater stability to the mold 16 and the support device 20 during a casting step.

The next step in the process is pouring the casting material into the cavity defined by the mold 16. The casting material can be selected from a wide variety of substances available on the market. One such material is hydrostone or gypsum product, which is considerably harder than regular Plaster of Paris. Other materials may be used for making the cast, for instance casting compositions containing melamine, fiberglass, and the like. For use in the present process, the dry powdered hydrostone was mixed with water at a ratio of 1:3 that is one cup of water per three cups of dry gypsum substance. The resultant cementitious material was mixed until it became a homogeneous mixture and then slowly poured into the mold 16. If the casting medium is poured too fast, air bubbles may form in the casting medium, which may adversely affect the appearance of the finished product. The air bubbles can be removed by lightly tapping on the cage 20 to release any unwanted air bubbles.

The casting medium is allowed to dry for 35-45 minutes or until it cures. Following the curing process, the cage 20 is fully removed from the mold 16, as shown in FIG. 8, while the mold 16 is inverted. Next, the flexible mold 16 is “peeled” from the hardened casting 30, leaving a primary cast 30, which exterior surface closely resembles the exterior surface of the petrified wood item 10. The casting 30 is allowed to harden or cure for an additional time, about 24-48 hours to make sure that the gypsum is completely hardened and cured.

If desired, the finished casting 30 can be painted to resemble the petrified wood, that is the starting item. Alternatively, the casting can be further processed to make secondary castings that can be used as utilitarian objects. In the optional steps of the process, the cast 30 is worked by forming an inner recess 32 in its top region. The recess can be formed by using conventional tools, for instance a router with a mortise bit to cut into the hardened cast 30, as illustrated in FIG. 10. If desired, an interior groove 34 may be formed in the recess 32. The inner recess 32 may then be polished or buffed in forming smooth interior and the groove 34.

It is suggested that any dust particles be removed from the surface from the casting 30 so as to make it readily available for painting and decorating. If desired the casting may be allowed to cure for an additional 1 or 2 days so as to more closely resemble in physical characteristics the petrified wood item.

In making the secondary castings, the artisan first makes a secondary mold by depositing one or more layers of resinous substance on the cast 30, similar to the procedure described above and shown in FIG. 2. An open-weave fabric is then applied and secured with the resinous substance with additional layer(s) of the latex coating, similar to the process shown in FIG. 3. The artisan then allows the latex coatings and the fabric to bond together and form a secondary mold, which is removed from the cast 30, similar to the step shown in FIG. 4.

The new mold is removed from the parent casting and the interior cavity is stuffed with loose flexible collapsible material, for instance crunched up paper towels and the like. The cavity is stuffed to prevent the new mold from collapsing. The user may use the same support device that was used when supporting the original mold 16 or fashion another support device by wrapping the exterior of the secondary casting with a wire mesh. Then the secondary mold is inserted into the support device, sprayed with mold release material and positioned on a sturdy surface, similar to the sand surface 29 in the container 28.

A cementitious liquid composition, for instance the same hydrostone mixture is poured into the interior cavity defined by the secondary mold. After the hydrostone cured for 72 or more hours, the mold is removed from the cast, similar to the step shown in FIG. 8. The resultant secondary cast can be decorated or painted in the color scheme resembling the original petrified wood item. The original petrified wood item is used as a guide for the mixing and application of different color paint.

A wide variety of items can be made using the process of the present invention. The “mother” mold can be used to produce candleholders, planters, vases, birdbaths and the like. If the product is to be used outdoors a weatherproof substance can be added to the casting mixture. The resultant utilitarian articles are structurally sound, generally lightweight and decorative. The gypsum material provides the desired structural and the textural properties, which lend themselves to application of decorative elements on the exterior of the cast object.

Many changes and modifications can be made to the method of the present invention without departing from the spirit thereof. I therefore pray that my rights to the present invention be limited only by the scope of the appended claims.

I claim:

1. A process for making a three-dimensional article, comprising the steps:
providing a three-dimensional naturally occurring item;
applying a coat of liquid resinous substance to at least one or more exterior surfaces of the item;
positioning a loose open-weave fabric over the at least one or more coated surfaces and securing the fabric with an additional coat of the liquid resinous substance;
partially curing the resinous substance to form a flexible deformable primary mold having an inner cavity configured as a mirror image of the item;
providing a primary support structure for supporting the primary mold and positioning the primary mold in said primary structure;
pouring curable casting substance into the primary mold cavity and allowing the casting substance to cure, thereby forming the three-dimensional article.

2. The method of claim 1, further comprising the step of removing the primary mold and the primary cage from the cured casting.

3. The method of claim 2, further comprising the step of decorating the casting to resemble the naturally occurring item.

4. The method of claim 1, wherein said primary support structure is formed from a stable mesh material.

5. The method of claim 1, wherein said open-weave fabric comprises cotton gauze.

6. The method of claim 1, wherein said casting substance comprises gypsum.

7. The method of claim 1, further comprising the step of forming a cavity in a top portion of the casting.

8. The method of claim 1, wherein said casting is allowed to cure for at least 72 hours.

9. The method of claim 2, further comprising the step of applying one or more of resinous substance to the casting, positioning an open weave fabric on said layers and securing the fabric on said casting; then allowing the resinous substance to cure, thereby forming a secondary deformable mold having an inner cavity.

10. The method of claim 9, further comprising the step of providing a secondary support means for supporting the secondary mold and positioning the secondary mold in the secondary support means.

11. The method of claim 10, further comprising the step of depositing liquid casting substance into the cavity of the secondary mold and allowing the casing substance to cure to form a secondary casting of the three-dimensional article.

12. The method of claim 11, further comprising the step of decorating the secondary casting to resemble the naturally occurring item.

13. The method of claim 11, wherein said casting is allowed to cure for at least 72 hours.

14. A method for producing an image of petrified wood on one or more surfaces of a three-dimensional article, comprising the steps of:
providing an item of petrified wood;
applying a liquid resinous coat to at least the one or more surfaces of the petrified wood item;
partially drying the coat and securing a layer of an open weave fabric on said coat;
allowing the coat to cure with the fabric layer and to form a primary flexible deformable mold having an inner cavity;
removing the primary mold from the item of petrified wood;
providing an open-mesh cage and positioning the primary mold in said cage;
pouring liquid casting substance into the cavity of the primary mold; and
allowing the casting material to cure and form a primary casting duplicating exterior configuration of the petrified wood item.

15. The method of claim 14, wherein said resinous coat comprises a latex composition.

16. The method of claim 14, wherein said casting material comprises gypsum.

17. The method of claim 14, further comprising the step of decorating exterior surface of the primary casting to resemble the item of petrified wood.

18. The method of claim 14, further comprising the step of forming a decorative product from said primary casting, said step comprising the steps of preparing one or more surfaces of the primary casting including forming, routing, drilling, forming recesses, cutting or painting of the primary casting.

19. A molded decorative article made according to the method of claim 14.

20. A molded, decorative article comprising:
a body portion made of a cementitious composition, said body portion including an exterior decorative surface resembling petrified wood.

21. The article of claim 19, wherein said body portion is provided with a recessed top region.

22. The article of claim 20, wherein said cementitious composition comprises gypsum.

23. A molded article made according to the method comprising:
providing an item of petrified wood;
applying a liquid resinous coat to at least one or more surfaces of the petrified wood item;
partially drying the coat and securing a layer of an open weave fabric on said coat;
allowing the coat to cure with the fabric layer and to form a primary flexible deformable mold having an inner cavity;
removing the primary mold from the item of petrified wood;
providing an open-mesh cage and positioning the primary mold in said cage;
pouring liquid cementitious substance into the cavity of the primary mold; and
allowing the casting material to cure and form a primary casting duplicating exterior configuration of the petrified wood item.

24. The article of claim 23, wherein said open weave fabric comprise gauze.

25. The article of claim 23, wherein said liquid resinous coat comprises a latex composition.

26. The article of claim 23, wherein said cementitious substance comprises gypsum.

27. The article of claim 23, wherein exterior surface of the primary casting is painted to resemble the item of petrified wood.
